(19) United States
(12) Patent Application Publication
(10) Pub. No.: US 2020/0065559 A1
(43) Pub. Date: Feb. 27, 2020

(54) Generating a video using a video and user image or video

(71) Applicant: Nitin Vats, Bengaluru (IN)

(72) Inventor: Nitin Vats, Bengaluru (IN)

(21) Appl. No.: 16/350,070

(22) Filed: Aug. 22, 2018

(51) Int. Cl. G06K 9/00; G06T 7/20; H04N 19/44; G06K 9/46

(52) U.S. Cl. CPC G06K 9/00228; G06T 7/20; G06K 9/46; G06K 9/00335; H04N 19/44; G06K 9/00302

(57) ABSTRACT

A method for generating a video using user image/video includes providing an user image/video based on user input to a processor, the user image/video comprises a face, receiving a scene video which comprises a body model of a person whereas body model of a person represent an image of a human with specified face region, extracting the face image/s from user image/video, receiving a face position information in different frames of scene video, processing the extracted face image/s and the frames of the scene video using the face position information and generating a processed video, and the processed video comprises the face and the body model aligned together to represent a single person. The face region is the space for face with/without neck portion and/or hair in scene video frame. The face position information comprises at least one of tilt of face, orientation of face, geometrical location of face region, boundary of face region and zoom of the face region. The extracted face image is defined by the face or the face with/without neck portion and/or hair and/or nearby portion in user image.

### FIELD OF THE INVENTION

The invention relates to image/video processing. More particularly, the invention relates to image/video processing of a user image/video of human body with another video to generate user's video.

### BACKGROUND

Personalization of a video is generally required to give person a realistic experience of a particular object or environment. Currently, it is limited to video morphing of one face on other face in a video. Morphing involves manual processing on each frame of a video, which makes such video processing time consuming too. Such processing is error prone and unrealistic.

This limits user experience to a large extent. There exist no solution where a user can just by uploading a photo can generate a video scenarios like riding a bike by himself, him being dancing on particular dance steps, etc.

Also in case of virtual trail of apparels, the traditional methods generate the 3d animation which gives artificial look. There exists no solution for making realistic video of virtual trial.

### SUMMARY OF THE INVENTION

The object of the invention is achieved by a method of the Claim 1, a system of Claim 37, a computer program product of Claim 39.

According to an embodiment of the method, the method includes
providing an user image/video based on user input to a processor, the user image/video comprises a face;
receiving a scene video which comprises a body model of a person whereas body model of a person represent an image of a human with specified face region
extracting the face image/s from user image/video;
receiving a face position information in different frames of scene video;
processing the extracted face image/s and the frames of the scene video using the face position information;
generating processed video, the processed video comprises the face and the body model aligned together to represent a single person.

The face region is the space for face with/without neck portion and/or hair in scene video frame. The face position information comprises at least one of tilt of face, orientation of face, geometrical location of face region, boundary of face region and zoom of the face region. The extracted face image is defined by the face or the face with/without neck portion and/or hair and/or nearby portion in user image.

According to another embodiment of the method, wherein scene video is pre-processed to provide the scene video where body model of person is with removed face region

According to yet another embodiment of the method, wherein extracting the face image comprises extracting the face cropped with neck from user image/video

According to one embodiment of the method, wherein extracting the face image comprises extracting the face cropped with hair from user image/video

According to another embodiment of the method, wherein extracting the face image comprises extracting the region from user image, which includes face.

According to yet another embodiment of the method, wherein extracting the face image based on a extraction input, wherein the extraction input comprises selection of at least one of face, hair, neck, region around face.

According to one embodiment of the method, wherein the scene video is provided as per the body shape and/or size information provided by the user.

According to another embodiment of the method, wherein the person's body in scene video is reshaped to be in different shape and size.

According to yet another embodiment of the method, wherein the scene video comprises a background, and processing the scene video to remove the background.

According to one embodiment of the method, wherein the video with user image/s is processed with background image/video to generate processed video

According to another embodiment of the method, wherein the input scene video is provided with removed face with face position information of each frame.

According to yet another embodiment of the method, wherein at least a set of user images are provided which show same face in two slightly different perspective and are processed with a set of video which shows same scene in slightly different perspective to generate a set of video which show user image with body of person in scene video in slightly different perspective.

According to one embodiment of the method, the method includes:
receiving a face area Information comprising information of at least an area showing hair, head and/or neck wearable, face wearable and an object covering face of body model, in different frames of scene video;
processing the extracted face image and the frames of the scene video using the information of face position information and the face area information.

According to another embodiment of the method, wherein the scene video frames comprises at least a vehicle, a background, a helmet, hair.

According to yet another embodiment of the method, wherein providing a group photo or a single person video or group video based on user input, and selecting a face based on selection user input, processing the group photo or the single person video or the group video based on the selection user input to generate the user image/video with face.

According to one embodiment of the method, wherein the scene video comprises more than one body model of persons, the method comprising:
providing one or more user image/video having one or more faces and selecting faces for body models based on user selection input.

According to another embodiment of the method, the method includes:
processing the scene video to elect the face region of body model of the person in scene video by the processor from the scene video frames; and
generate face position information.

According to yet another embodiment of the method, the method includes:
receiving skin tone input related to skin tone or detecting skin tone information from the face of the user image/video;
providing the video frames of the body model in matching skin tone either from a database based on the skin tone input/skin tone information or by processing the body model skin colour based on the skin tone input/skin tone information in scene video frames.

According to one embodiment of the method, the method includes:
merging of extracted face image/s with the body model of person at neck in the scene video frame/s.

According to another embodiment of the method, the method includes:
processing the extracted face in different frame/s of scene video with at least one of environment lighting, shading, overlay glass effect on/around the face.

According to yet another embodiment of the method, the method includes:
receiving wearable/hair position information in scene video frames whereas scene video comprises body of a person with or without face with hair/wearable/s at head/face location;
receiving the new wearable/hair image/s for replacing/overlaying the original wearable/hair;
processing the new wearable/hair, the extracted face, the frames of the scene video of body model of the person using the face position information and wearable/hair position information.

The wearable are defined by any object worn or to be worn on head or face. The wearable/hair position information comprises information about at least one of tilt, orientation, geometrical location and zoom of the hair/wearable.

According to one embodiment of the method, the method includes:
receiving the user images/video of face in different orientation;
selection based on user input or detection by processor of the received face images before or after extraction of face from the user images/video frames according to their orientation;
using the face image of particular orientation in respective scene e video frames according to face position information.

According to another embodiment of the method, wherein the images of face in different orientations are extracted from a video of the face having the face being placed in different orientation in different video frames.

According to yet another embodiment of the method, wherein the images of the face in different orientations is extracted from rendering a three dimensional computer graphics user face model.

According to one embodiment of the method, wherein the three dimensional computer graphics user face model is generated by using the images of the face in one or more orientation.

According to another embodiment of the method, the method includes:
receiving input to apply makeup;
detecting face parts for from the face in user image/video;
Changing color or tone to apply make-up on the face parts.

The input to apply makeup is received before or after face image extraction or after generation of processed video

According to yet another embodiment of the method, the method includes:
receiving input to apply makeup;
detecting face parts from the user image/video;
receiving a make-up image from database
processing the detected face part and the make-up image.

The input to apply makeup is received before or after face image extraction or after generation of processed video.

According to one embodiment of the method, the method is adapted to generate at least one processed video, the method includes:
receiving a frame segment information;
processing the extracted face image/s and the frames of the scene video using the information of face position and the frame segment information;
generating at least one processed video.

The frame segment information is related to information regarding different set of frames being used to generate different processed videos.

According to another embodiment of the method, the method includes:
receiving at least one add-on video;
receiving an order information;
processing the processed video/s with add-on video/s using the order information to generate a complete video.

The order information defines an order in which the add-on video/s are to be merged with processed video/s.

According to yet another embodiment of the method, the method includes:
extracting face expression information from the body model face in different scene video frame;
processing the extracted face image/s and scene video frames using face position information and face expression information to generate the processed video

The face expression information comprises at least one of an facial expression or lipsing.

According to one embodiment of the method, the method includes:
providing a sound input related to a sound;
processing the processed video with the sound input to generate the processed video with the sound.

According to another embodiment of the method, the method includes:
providing a face expression information;
processing the extracted face in processed video frames based on the face expression information to generate the processed video.

The face expression information comprises at least one of a facial expression or lisping.

According to yet another embodiment of the method, the method includes:
providing user input for facial expression;
processing the user input for facial expression to extract the face expression information.

According to one embodiment of the method, wherein receiving the scene video in real time, processing the extracted face image with scene video to generate the processed video continuously and displaying the processed video on display device.

According to another embodiment of the method, wherein receiving stream of the scene video, storing scene video of sometime duration, processing extracted face image with scene video of such time duration and generating the processed video and displaying the processed video on display device.

According to yet another embodiment of the method, wherein generating the processed video and/or the complete video using multithreading and/or parallel processing techniques.

### BRIEF DESCRIPTION OF THE DRAWINGS

FIG. 1 (a)-(c) illustrates different frames of video of person riding bike with which user face image is to be processed.

FIG. 2(a)-(c) illustrates selecting face portion in different frames of input video

FIGS. 3(a) and 3(b) illustrates input image of user and selecting face after face detection.

FIG. 4 (a)-(d) illustrates frames of input with detected face at face portion of input video frames in synchronies with helmet and frames with makeup and wearable on face.

FIGS. 5(a) and 5(b) illustrates different frames of video of person in different posture with which user face image is to be processed.

FIGS. 6(a) and 6(b) illustrates selecting face portion in different frames of input video as in FIGS. 5(a) and 5(b)

FIGS. 7(a) and 7(b) illustrates input image of user and selecting face after face detection.

FIG. 8 (a)-8(c) illustrates frames of input with detected face at face portion of input video frames in synchronies with hairs and with makeup and wearable.

FIG. 9(a)-FIG. 9(b) illustrates the points showing facial feature on user face determined by processing the image using trained model to extract facial feature and segmentation of face parts for producing facial expressions while FIG. 9(c)-(f) shows different facial expression on user face produced by processing the user face.

FIG. 10(a)-(c) illustrates the user input of front and side image and face unwrap.

FIG. 11(a)-FIG. 11(b) illustrates the face generated in different angle and orientation by generated 3d model of user face.

FIG. 12 illustrate the system diagram.

FIG. 13(a)-FIG. 13(f) illustrates the change in shape & size of the body of scene video frames and applying different background and environment effect in video frames.

FIGS. 14 (a) and 14(b) illustrates concept for changing shape and size of an image.

### DETAILED DESCRIPTION

The present invention describe system and method for generating a video by processing a video of a person whose face is to be replaced by one or more face image from an image provided by an user.

The portion of the face to be replaced in video frames of video of the person are accurately identified and the angle, orientation, zoom and position are acquired. Next the face that is to be replaced is identified and according mapped as per the requirement in particular frame and then placed/merged with the video frames and rendered to generate the video.

We can produce expression on replaced face as per the previous face or different than the video. User can also apply makeup, facial or nearby accessories such as spects, scarf, etc in video frames.

These steps make the morphing an automatic process and accurate process. So far it was either manual process or producing wrong results.

In one of the embodiment, the steps to implement the invention are as follows;
An image/video is provided by user whose face is to be used in processed video.
Processor receives the video of the person and the Information about at least one of a face boundary, an orientation and scale in different frames where the persons face is present
Extracting the face image/s from image/video provided by user
Processing the extracted face with using information such as face boundary, orientation, and scale with the frames of video.
Optionally using facial features information which is extracted using the image and applying makeup, fashion accessories images such as spects, scarf, etc on face or nearby area.
Optimally merging the face with the video at neck and nearby area
Applying facial expression on the changed face in frames as shown in the original face of video or may be different from that
Encoding the frames to generate the video
Optionally sharing the video to social networking sites or other sites

As per another embodiment, an image/video is provided by user whose face is extracted after face detection. Extracted face image or one or more extracted face video frames is to be processed with scene video frames. Face is placed at desired location at frames so that body of person in video frame fits with user face while user face can be zoomed, tilted considering orientation as required in particular frame. If there is any face wearable such as helmet etc or face is placed with hair of person in scene video frame, then face is processed so that it looks like fitted with helmet/hair and body. In case some make up or accessory is applied on face then face parts such as chicks, eyes, lips are detected and color/contrast/brightness are changed to show the effect of makeup or image of spects or jewelry is placed at respected face part and processed together with video frame and face.

Database includes:
Video of a person;
Information about face boundary, orientation and scale in different frames where selected face is present;
Face Accessory images such as spects, jewelry.

In one embodiment, the aspects of invention are implemented by a method using following steps whereas steps are processed in any order which is different than following order:
An image/video is provided by user whose face is to be used in processed video.
Processor receives the video of the person and the Information about at least one of a face boundary, an orientation and scale in different frames where the persons face is present
Extracting the face image/s from image/video provided by user
Processing the extracted face with using information such as face boundary, orientation, and scale with the frames of video.
Encoding the frames to generate the video
Optionally sharing the video to social networking sites or other sites

As per yet another embodiment, one or more image/video is provided by user whose face is extracted after face detection. Extracted face image or one or more extracted face video frames is to be processed with scene video frames. The scene video contains at least one person with face whose face is to be replaced with the face as per user input. The scene video can be processed to change the shape of the person's body. The body of the person in scene video frames are detected. The body is warped to change in the shape & size. The background is removed before or after of the warping. Thus we have frames with face area detected with body of person with changed shape and size.

Input face is placed at desired location at frames so that body of person in video frame fits with user face while user face can be zoomed, tilted considering orientation as required in particular frame. If there is any face wearable such as helmet etc or face is placed with hair of person in database video frame, then face is processed so that it looks like fitted with helmet/hair and body. In case some make up or accessory is applied on face then face parts such as chicks, eyes, lips are detected and color/contrast/brightness are changed to show the effect of makeup or image of spects or jewelry is placed at respected face part and processed together with video frame and face.

Thus the application will function in a way as explained below;
input the image/video of person having face
input the information regarding user's body shape/size
detecting the most appropriate video of person is similar shape & size with face area and or other features detected or processing the video in run time to make body of person in desired shape & size
output the video of person with user input face and body of the person

According to yet another embodiment, at least a set of two image/two video is provided by user which have face in two slightly different perspective, whose faces are extracted after face detection. Extracted set of face images or one or more extracted face video frames is to be processed with scene respective video frames whereas video set also have body of person in slightly different perspective. Face is placed at desired location at frames so that body of person in video frame fits with user face while user face can be zoomed, tilted considering orientation as required in particular frame. Encoding the frames of set video frames with user set of images generate a set of videos. Such videos can be seen by special 3d glasses or by the head mounted display or immersive head mount display for fully 3D viewing of the video by feeding two video of same scene with slightly different perspective to make a complete 3D viewing. Immersive head mount display shows video in virtual environment which is immersive

The Application Data includes the Database for image processing, profile database and Supporting Libraries.

The database for image processing includes video/animation, images, face position information of different scene videos, Trained model data which is generated by training with lots of faces/body and help in quickly extracting facial and body features Whereas video includes scene video which are pre-processed to identify face position information or produce face position information during processing, scene video with removed face, background videos, animations, video of person in different body shape and size with or without face with or without background, video-set of a person where two videos are showing same scene in slight different angle for 3d visualization. The images includes image/s of user face as per the user profile, image for makeup, fashion accessories, background, effects.

The Profile database of user is provided for keeping data related to each of the users.

Supporting Libraries includes one or more libraries described as follows: face & facial feature extraction trained model, skin tone detection model, model to create animation in face part, face orientation and expression finding engine form a given video, tool to wrap or resize the body as per input shape & size, body detection model, 3D face/body generation engine from images, libraries for image merging/blending, video encoding library, video frames extraction library.

As per one embodiment of the method, the method for generating a video using user image/video includes:
providing an user image/video based on user input to a processor, the user image/video comprises a face;
receiving a scene video which comprises a body model of a person whereas body model of a person represent an image of a human with specified face region
extracting the face image/s from user image/video;
receiving a face position information in different frames of scene video;
processing the extracted face image/s and the frames of the scene video using the face position information;
generating processed video, the processed video comprises the face and the body model aligned together to represent a single person.

The face region is the space for face with/without neck portion and/or hair in scene video frame. The face position information comprises at least one of tilt of face, orientation of face, geometrical location of face region, boundary of face region and zoom of the face region. The extracted face image is defined by the face or the face with/without neck portion and/or hair and/or nearby portion in user image.

User can optionally provide more than one images or sequence of images whereas different images can be used for different frame of scene video in such a way that make video continuous or face of user look in synchronization with the body of person in scene video

The display system can be a wearable display or a non-wearable display or combination thereof.

The non-wearable display includes electronic visual displays such as LCD, LED, Plasma, OLED, video wall, box shaped display or display made of more than one electronic visual display or projector based or combination thereof.

The non-wearable display also includes a pepper's ghost based display with one or more faces made up of transparent inclined foil/screen illuminated by projector/s and/or electronic display/s wherein projector and/or electronic display showing different image of same virtual object rendered with different camera angle at different faces of pepper's ghost based display giving an illusion of a virtual object placed at one places whose different sides are viewable through different face of display based on pepper's ghost technology.

The wearable display includes head mounted display. The head mount display includes either one or two small displays with lenses and semi-transparent mirrors embedded in a helmet, eyeglasses or visor. The display units are miniaturised and may include CRT, LCDs, Liquid crystal on silicon (LCos), or OLED or multiple micro-displays to increase total resolution and field of view.

The head mounted display also includes a see through head mount display or optical head-mounted display with one or two display for one or both eyes which further comprises curved mirror based display or waveguide based display. See through head mount display are transparent or semitransparent display which shows the output video in front of users eye/s while user can also see the environment around him/her as well.

The head mounted display also includes video see through head mount display or immersive head mount display for fully 3D viewing of the video by feeding two video of same scene with slightly different perspective to make a complete 3D viewing. Immersive head mount display shows video in virtual environment which is immersive.

There Exist Various Methods for Face detection which are based on either of skin tone based segmentation, Feature based detection, and template matching or Neural Network based detection. For example; Seminal work of Viola Jones based on Haar features is generally used in many face detection libraries for quick face detection.

Haar Feature is define as follows:

Lets consider a term “Integral image” which is similar to the summed area table and contains entries for each location such that entry on (x, y) location is the sum of all pixel values above and left to this location.

$$ii ( x , y ) = {\sum }_{{x}^{′} \leq x , {y}^{′} \leq y} i ( {x}^{′} , {y}^{′} )$$

where ii(x, y) is the integral image and i(x, y) is original image.

Integral image allows the features (in this method Haar-like-features are used) used by this detector to be computed very quickly. The sum of the pixels which lie within the white rectangles are subtracted from the sum of pixels in the grey rectangles. Using integral image, only six array reference are needed to compute two rectangle features, eight array references for three rectangle features, etc which let features to be computed in constant time O(1).

After extracting Feature, The learning algorithm is used to select a small number of critical visual features from a very large set of potential features Such Methods use only few important features from large set of features after learning result using Learning algorithm and cascading of classifiers make this real time face detection system.

In realistic scenario users upload pics which are in different orientation and angels. For such cases, Neural Network based face detection algorithms can be used which leverage the high capacity of convolution networks for classification and feature extraction to learn a single classifier for detecting faces from multiple views and positions. To obtain the final face detector, a Sliding window approach is used because it has less complexity and is independent of extra modules such as selective search. First, the fully connected layers are converted into convolution layers by reshaping layer parameters. This made it possible to efficiently run the Convolution Neural Network on images of any size and obtain a heat-map of the face classifier.

Once we have a detected the face, the next is to find the location of different facial features (e.g. corners of the eyes, eyebrows, and the mouth, the tip of the nose etc.) accurately.

For an Example; to precisely estimate the position of facial landmarks in a computationally efficient way, one can use dlib library to extract facial features or landmark points.

Some methods are based on utilizing a cascade of regressors. The cascade of regressors can be defined as follows:

Let xᵢ∈R² be the x, y-coordinates of the ith facial landmark in an image I. Then the vector S=(x₁^{T}, x₂^{T}, . . . xₚ^{T})^{T}∈R^{2p} denotes the coordinates of all the p facial landmarks in I. The vector S represent the shape. Each regressor, in the cascade predicts an update vector from the image. On Learning each regressor in the cascade, feature points estimated at different levels of the cascade are initialized with the mean shape which is centered at the output of a basic Viola & Jones face detector.

Thereafter, extracted feature points can be used in expression analysis and generation of geometry-driven photorealistic facial expression synthesis.

For applying makeup on lips, one need to identify lips region in face. For this, after getting facial feature points, a smooth Bezier curve is obtained which captures almost whole lip region in input image. Also, Lip detection can be achieved by color based segmentation methods based on color information. The facial feature detection methods give some facial feature points (x, y coordinates) in all cases invariant to different light, illumination, race and face pose. These points cover lip region. However, drawing smart Bezier curves will capture the whole region of lips using facial feature points.

Generally Various Human skin tone lies in a particular range of hue and saturation in HSB color space (Hue, Saturation, and Brightness). In most scenario only the brightness part varies for different skin tone, in a range of hue and saturation. Under certain lighting conditions, color is orientation invariant. The studies show that in spite of different skin color of the different race, age, sex, this difference is mainly concentrated in brightness and different people's skin color distributions have clustering in the color space removed brightness. In spite of RGB color space, HSV or YCbCr color space is used for skin color based segmentation.

Merging, Blending or Stitching of images are techniques of combining two or more images in such a way that joining area or seam do not appear in the processed image. A very basic technique of image blending is linear blending to combine or merge two images into one image: A parameter X is used in the joining area (or overlapping region) of both images. Output pixel value in the joining region:

P_{Joining_Region}(i,j)=(1−X)*P_{First_Image}(i,j)+X*P_{Second_Image}(i,j).

Where 0<X<1, remaining region of images are remain unchanged.

Other Techniques such as ‘Poisson Image Editing (Perez et al.)’, ‘Seamless Stitching of Images Based on a Haar Wavelet 2d Integration Method (Ioana et al.)’ or ‘Alignment and Mosaicing of Non-Overlapping Images (Yair et al.)’ can be used for blending.

For achieving life-like facial animation various techniques are being used now-a day's which includes performance-driven techniques, statistical appearance models or others. To implement performance-driven techniques approach, feature points are located on the face of an uploaded image provided by user and the displacement of these feature points over time is used either to update the vertex locations of a polygonal model, or are mapped to an underlying muscle-based model.

Given the feature point positions of a facial expression, to compute the corresponding expression image, one possibility would be to use some mechanism such as physical simulation to figure out the geometric deformations for each point on the face, and then render the resulting surface. Given a set of example expressions, one can generate photorealistic facial expressions through convex combination. Let Eᵢ=(Gᵢ, Iᵢ), i=0, . . . , m, be the example expressions where G represents the geometry and Ii is the texture image. We assume that all the texture images Iᵢ are pixel aligned. Let H(E₀, E₁, . . . , Eₘ) be the set of all possible convex combinations of these examples. Then

$$H ( {E}_{0} , {E}_{1} , … , {E}_{m} ) = \{ ( {\sum }_{i = 0}^{m} {c}_{i} {G}_{i} , {\sum }_{i = 0}^{m} {c}_{i} {I}_{i} ) \vert {\sum }_{i = 0}^{m} {c}_{i} = 1 , {c}_{i} \geq 0 , i = 0 , … , m \}$$

While the statistical appearance models are generated by combining a model of shape variation with a model of texture variation. The texture is defined as the pattern of intensities or colors across an image patch. To build a model, it requires a training set of annotated images where corresponding points have been marked on each example. The main techniques used to apply facial animation to a character includes morph targets animation, bone driven animation, texture-based animation (2D or 3D), and physiological models.

The feature extraction model recognizes a face, shoulders, elbows, hands, a waist, knees, and feet from the user shape, it extracts the body portion from the frames of scene video. Warping of body can produce body of different shape & size.

The invention is further explained through various illustrations.

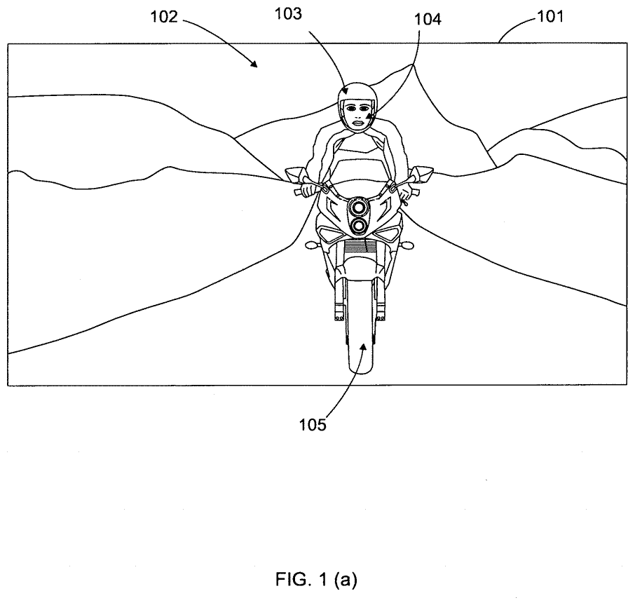

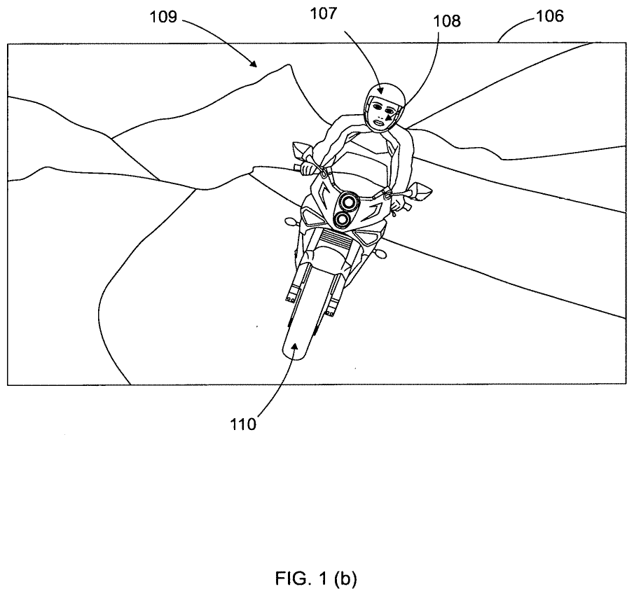

FIG. 1(a)-(c) illustrates different frames of video of person riding bike. FIG. 1(a) shows an image 101 which is frame of video having a vehicle in position 105, helmet position 103 whereas 102 in background environment and 104 shows the position of the portion of face where user image is to be processed to give an effect of user riding the vehicle. FIG. 1(b) shows an image 106 which is another frame of same video having a vehicle in position 110, helmet in position 107 whereas 109 in background environment and 108 shows the position of the portion of face where user image is to be processed to give an effect of user riding the vehicle. FIG. 1(c) shows an image 111 which is another frame of same video having a vehicle in position 115, helmet in position 112 whereas 114 in background environment and 113 shows the position of the portion of face where user image is to be processed to give an effect of user riding the vehicle.

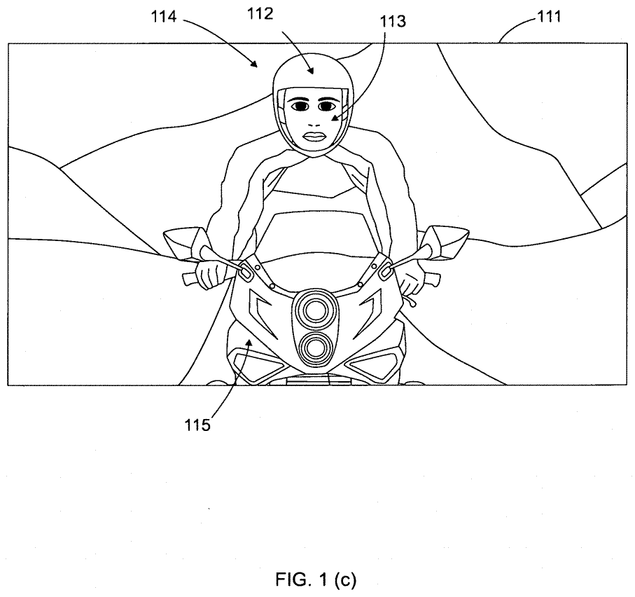

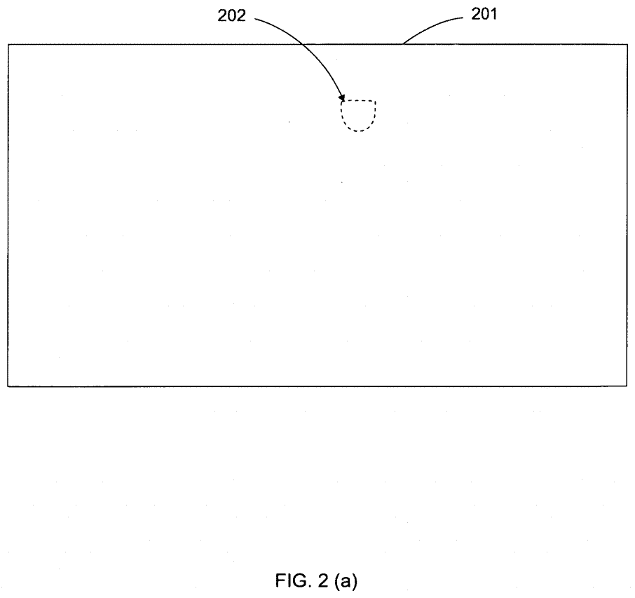

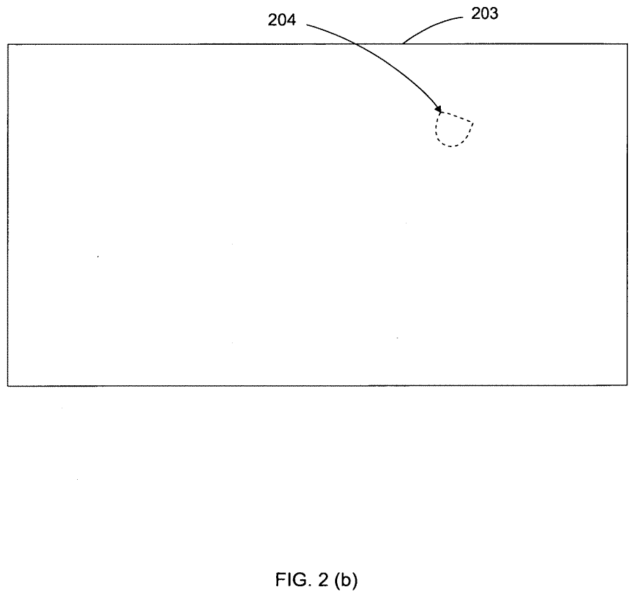

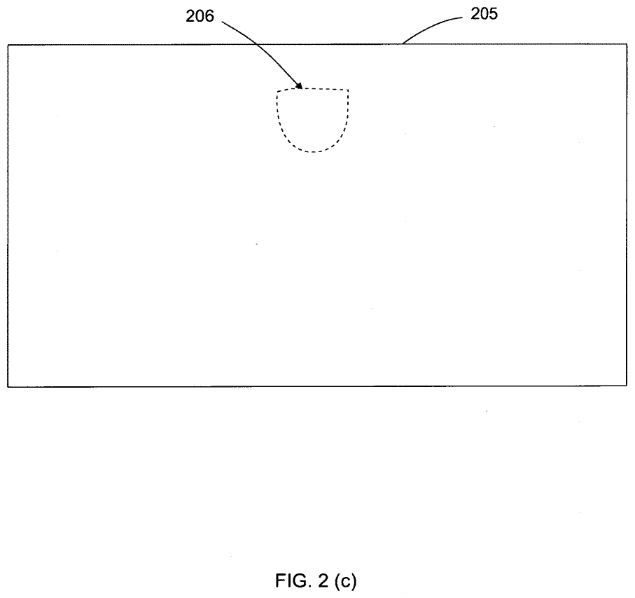

FIG. 2(a)-(c) illustrates selecting face portion in different frames of video. FIG. 2(a) shows 202 which represent video frame 101 and the face portion position 202. FIG. 2(b) shows 203 which represent video frame 106 and the face portion position 204. FIG. 2(c) shows 205 which represent video frame 111 and the face portion position 206.

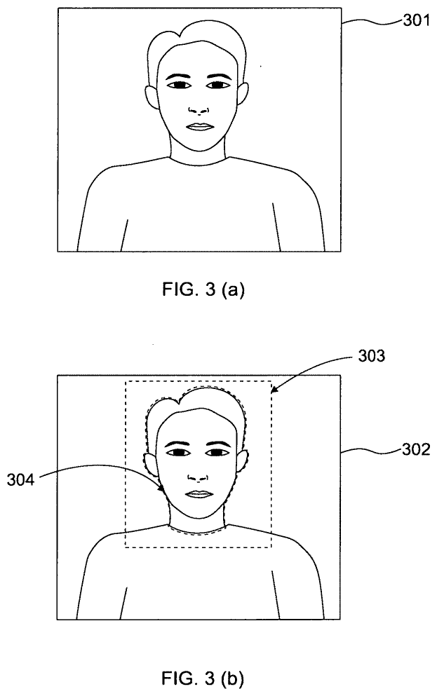

FIGS. 3(a) and 3(b) illustrates input image of user and selecting face after face detection. FIG. 3(a) input photo by user. FIG. 3(b) shows 302 where 303 is the area which enclose the face portion. 304 shows the face. The face is detected by the system and it after extraction is to be processed with video frames.

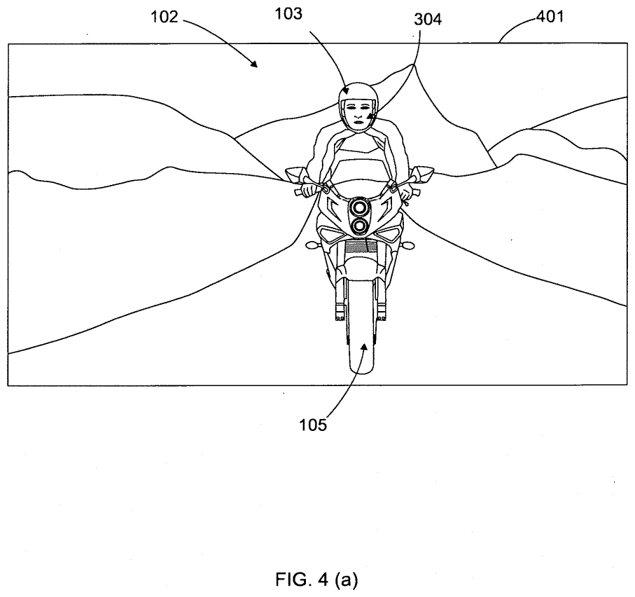

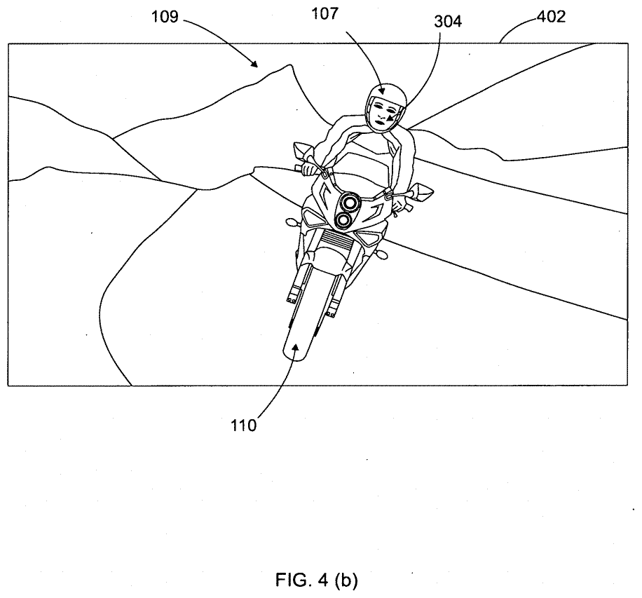

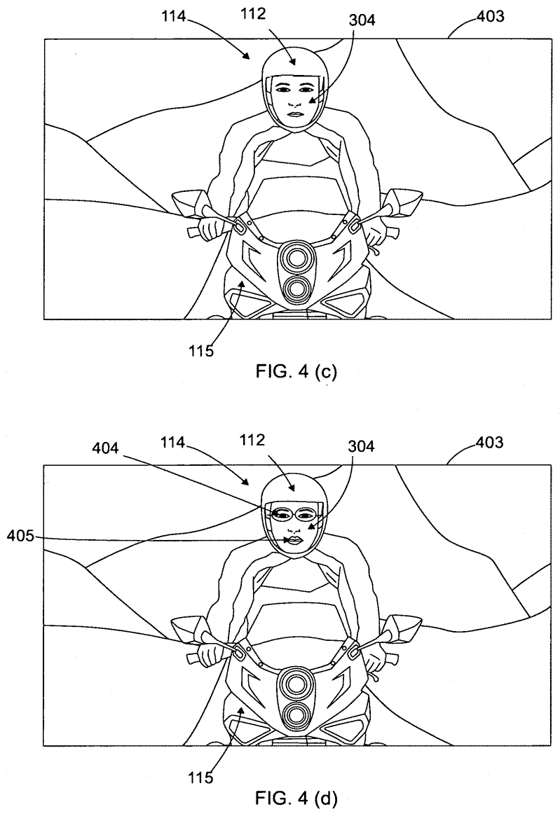

FIG. 4(a)-(c) illustrates different frames of video of person riding bike. FIG. 4(a) shows an image 401 which is the same frame as 101 of video, having a vehicle in position 105, helmet position 103 whereas 102 in background environment and 304 shows the user face fit with helmet to give an effect of user riding the vehicle. FIG. 4(b) shows an image 402 which is same frame as 106 of video, having a vehicle in position 110, helmet in position 107 whereas 109 in background environment and 304 shows the user face which is processed to give an effect of user riding the vehicle. FIG. 4(d) shows the applying of spects 404 and makeup as lipstick 405. The facial feature extraction model extract the position of lips and eyes and use the image of spects and color/image warped in the shape of lips on the face 304. It may be done after or before the face is merged with the scene video.

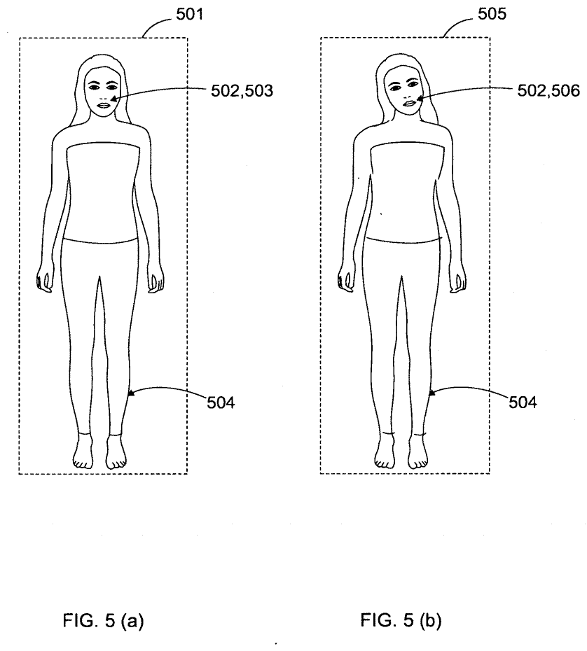

FIGS. 5(a) and 5(b) illustrates different frames of video of person in different postures. FIG. 5(a) shows an image 501 which is frame of video having a person 504 with face 502 and face position 503. FIG. 5(b) shows an image 505 which is frame of video having a person 504 with face 502 and face position 506.

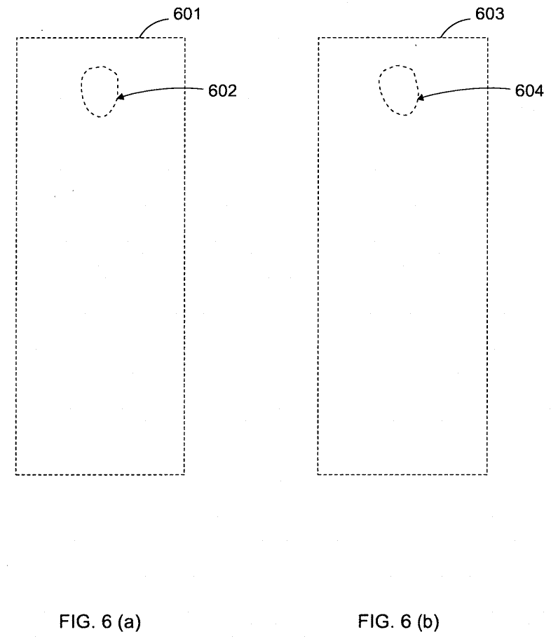

FIGS. 6(a) and 6(b) illustrates selecting face portion in different frames of video. FIG. 6(a) shows 601 which represent video frame 501 and the face portion position 602. FIG. 6(b) shows 603 which represent video frame 505 and the face portion position 604.

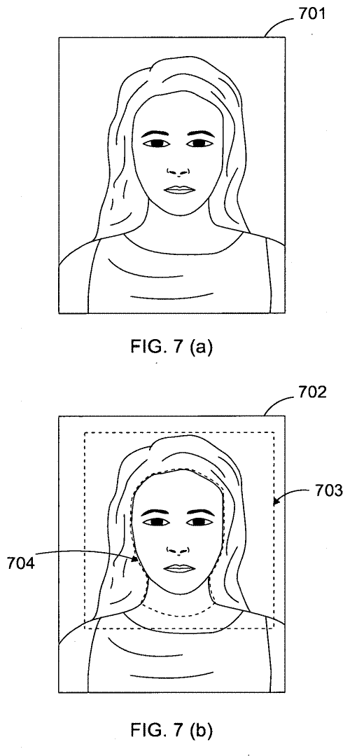

FIGS. 7(a) and 7(b) illustrates input image of user and selecting face after face detection. FIG. 7(a) input photo by user. FIG. 7(b) shows 702 where 703 is the area which enclose the face portion. 704 shows the face. The face is detected by the system and it after extraction is to be processed with video frames.

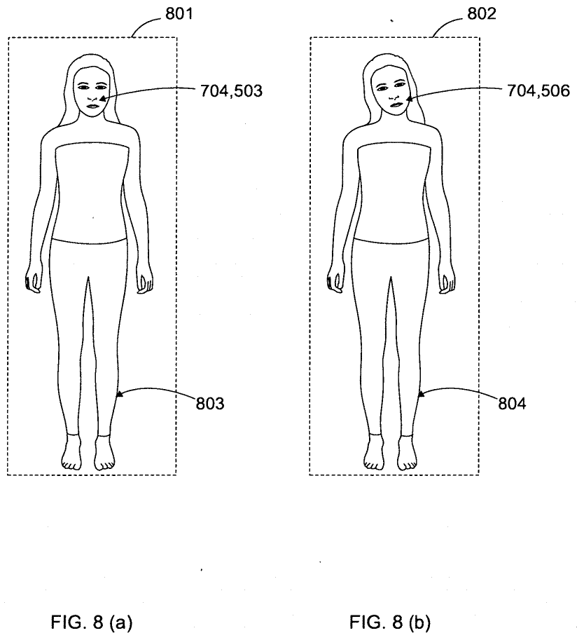

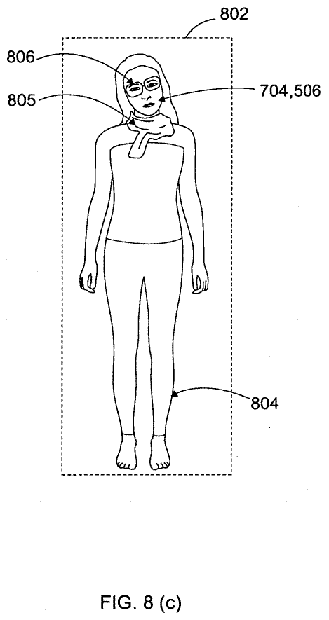

FIGS. 8(a) and 8(b) illustrates different frames of video of person in different postures. FIG. 8(a) shows an image 801 which is the same frame as 501 of video, having a person in face position 503, 704 shows the user face fit with hairs of 504 to give an effect of 504 with user face a single person. FIG. 8(b) shows an image 802 which is the same frame as 505 of video, having a person in face position 506, 704 shows the user face fit with hairs of 504 to give an effect of 504 with user face a single person. FIG. 8(c) shows the applying of spects 806 and scarf 805 in video frame.

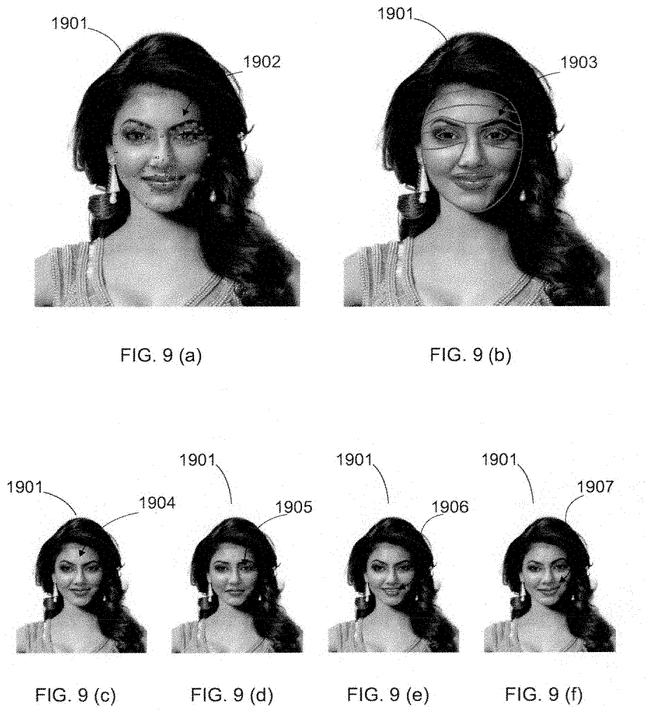

FIG. 9(a)-FIG. 9(b) illustrates the points showing facial feature on user face determined by processing the image using trained model to extract facial feature and segmentation of face parts for producing facial expressions while FIG. 9(c)-(f) shows different facial expression on user face produced by processing the user face.

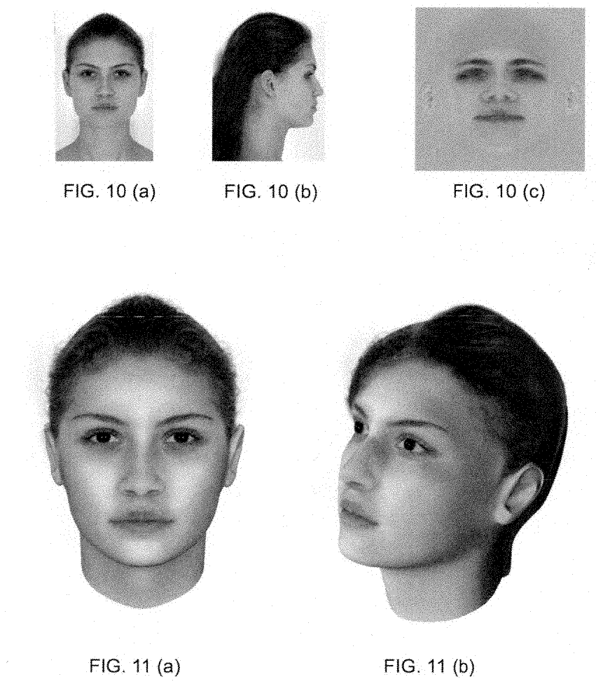

FIG. 10(a)-FIG (b) illustrates the user input of front and side image of face and FIG. 10 (c) show the face unwrap produced by logic of making 3d model of face using front and side image of face.

FIG. 11(a)-FIG. 11(b) illustrates the face generated in different angle and orientation by generated 3d model of user face. Once the 3D model of face is generated then it can be rendered to produce face in any angle or orientation to produce user body model in any angle or orientation using other person's body part/s image in same or similar orientation and/or angle.

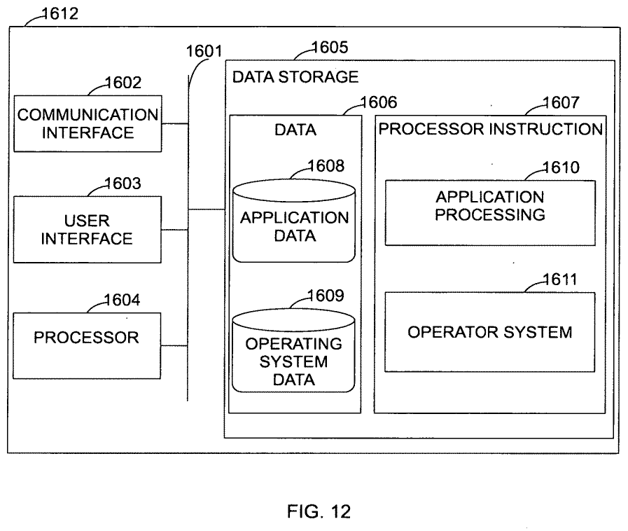

FIG. 12 shows the system diagram. FIG. 12 is a simplified block diagram showing some of the components of an example client device 1612. By way of example and without limitation, client device is an any device, including but not limited to portable or desktop computers, smart phones and electronic tablets, television systems, game consoles, kiosks and the like equipped with one or more wireless or wired communication interfaces. 1612 can include memory interface, data processor(s), image processor(s) or central processing unit(s), and peripherals interface. Memory interface, processor(s) or peripherals interface can be separate components or can be integrated in one or more integrated circuits. The various components described above can be coupled by one or more communication buses or signal lines.

Sensors, devices, and subsystems can be coupled to peripherals interface to facilitate multiple functionalities. For example, motion sensor, light sensor, and proximity sensor can be coupled to peripherals interface to facilitate orientation, lighting, and proximity functions of the device.

As shown in FIG. 8, client device 1612 may include a communication interface 1602, a user interface 1603, and a processor 1604, and data storage 1605, all of which may be communicatively linked together by a system bus, network, or other connection mechanism.

Communication interface 1602 functions to allow client device 1612 to communicate with other devices, access networks, and/or transport networks. Thus, communication interface 1602 may facilitate circuit-switched and/or packet-switched communication, such as POTS communication and/or IP or other packetized communication. For instance, communication interface 1602 may include a chipset and antenna arranged for wireless communication with a radio access network or an access point. Also, communication interface 1602 may take the form of a wireline interface, such as an Ethernet, Token Ring, or USB port. Communication interface 1602 may also take the form of a wireless interface, such as a Wifi, BLUETOOTH®, global positioning system (GPS), or wide-area wireless interface (e.g., WiMAX or LTE). However, other forms of physical layer interfaces and other types of standard or proprietary communication protocols may be used over communication interface 102 Furthermore, communication interface 1502 may comprise multiple physical communication interfaces (e.g., a Wifi interface, a BLUETOOTH® interface, and a wide-area wireless interface).

Wired communication subsystems can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data. The device may include wireless communication subsystems designed to operate over a global system for mobile communications (GSM) network, a GPRS network, an enhanced data GSM environment (EDGE) network, 802.x communication networks (e.g., WiFi, WiMax, or 3 G networks), code division multiple access (CDMA) networks, and a Bluetooth™ network. Communication subsystems may include hosting protocols such that the device may be configured as a base station for other wireless devices. As another example, the communication subsystems can allow the device to synchronize with a host device using one or more protocols, such as, for example, the TCP/IP protocol, HTTP protocol, UDP protocol, and any other known protocol.

User interface 1603 may function to allow client device 1612 to interact with a human or non-human user, such as to receive input from a user and to provide output to the user. Thus, user interface 1603 may include input components such as a keypad, keyboard, touch-sensitive or presence-sensitive panel, computer mouse, joystick, microphone, still camera and/or video camera, gesture sensor, tactile based input device. The input component also includes a pointing device such as mouse; a gesture guided input or eye movement or voice command captured by a sensor, an infrared-based sensor; a touch input; input received by changing the positioning/orientation of accelerometer and/or gyroscope and/or magnetometer attached with wearable display or with mobile devices or with moving display; or a command to a virtual assistant.

Audio subsystem can be coupled to a speaker and one or more microphones to facilitate voice-enabled functions, such as voice recognition, voice replication, digital recording, and telephony functions.

User interface 1603 may also be configured to generate audible output(s), via a speaker, speaker jack, audio output port, audio output device, earphones, and/or other similar devices, now known or later developed. In some embodiments, user interface 1603 may include software, circuitry, or another form of logic that can transmit data to and/or receive data from external user input/output devices. Additionally or alternatively, client device 112 may support remote access from another device, via communication interface 1602 or via another physical interface.

I/O subsystem can include touch controller and/or other input controller(s). Touch controller can be coupled to a touch surface. Touch surface and touch controller can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch surface. In one implementation, touch surface can display virtual or soft buttons and a virtual keyboard, which can be used as an input/output device by the user.

Other input controller(s) can be coupled to other input/control devices, such as one or more buttons, rocker switches, thumb-wheel, infrared port, USB port, and/or a pointer device such as a stylus. The one or more buttons (not shown) can include an up/down button for volume control of speaker and/or microphone.

The computer system can include clients and servers. A client and server are generally remote from each other and typically interact through a network. The relationship of client and server arises by virtue of computer programs running on the respective computers and having a client-server relationship to each other.

One or more features or steps of the embodiments can be implemented using an Application Programming Interface (API). An API can define on or more parameters that are passed between a calling application and other software code (e.g., an operating system, library routine, function) that provides a service, that provides data, or that performs an operation or a computation.

Processor 1604 may comprise one or more general-purpose processors (e.g., microprocessors) and/or one or more special purpose processors (e.g., DSPs, CPUs, FPUs, network processors, or ASICs).

Data storage 1605 may include one or more volatile and/or non-volatile storage components, such as magnetic, optical, flash, or organic storage, and may be integrated in whole or in part with processor 1604. Data storage 1605 may include removable and/or non-removable components.

In general, processor 1604 may be capable of executing program instructions 1607 (e.g., compiled or non-compiled program logic and/or machine code) stored in data storage 1505 to carry out the various functions described herein. Therefore, data storage 1605 may include a non-transitory computer-readable medium, having stored thereon program instructions that, upon execution by client device 1612, cause client device 1612 to carry out any of the methods, processes, or functions disclosed in this specification and/or the accompanying drawings. The execution of program instructions 1607 by processor 1604 may result in processor 1604 using data 1606.

By way of example, program instructions 1607 may include an operating system 1611 (e.g., an operating system kernel, device driver(s), and/or other modules) and one or more application programs 1610 installed on client device 1612 Similarly, data 1606 may include operating system data 1609 and application data 1608. Operating system data 1609 may be accessible primarily to operating system 1611, and application data 1608 may be accessible primarily to one or more of application programs 1610. Application data 1608 may be arranged in a file system that is visible to or hidden from a user of client device 1612.

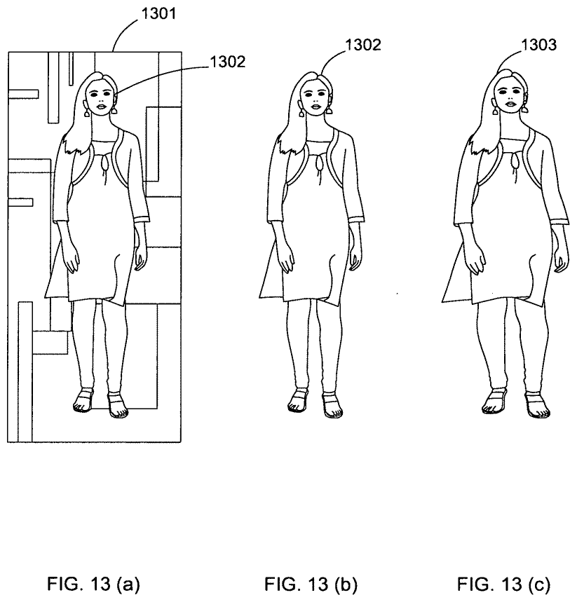

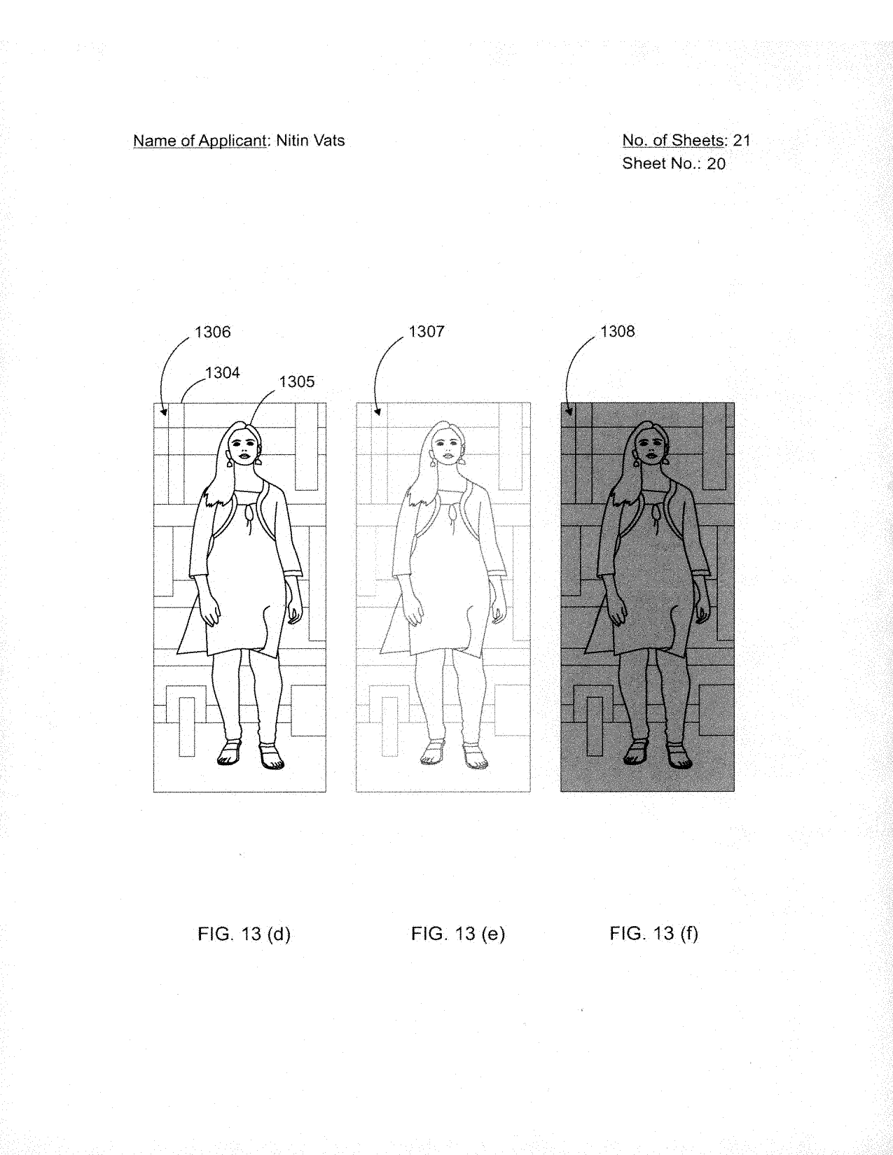

FIG. 13(a) shows a frame of scene video. FIG. 13(b) shows the frame with removed background which can be done by detecting the body area. FIG. 13 (c) shows the change in shape and size of the body of the frame. It can be done by warping the body portion. FIG. 13(c) is generated from the warping of FIG. 13(b). Now the face area can be removed and replaced by the user image. The image 13 (a) can be used with removed face or detected face region. The new scene video frame can be generated such as FIG. 13(d) by applying the background or putting environment effect such as sun or shade as in FIG. 13(e)-13(f). The background and/or environmental effect can be done after or before the face is replaced.

The scene video frames can be changed in the required shape & size before replacing the face or after replacing the face. System can also use pre-processed scene video frame which shows body in similar shape & size.

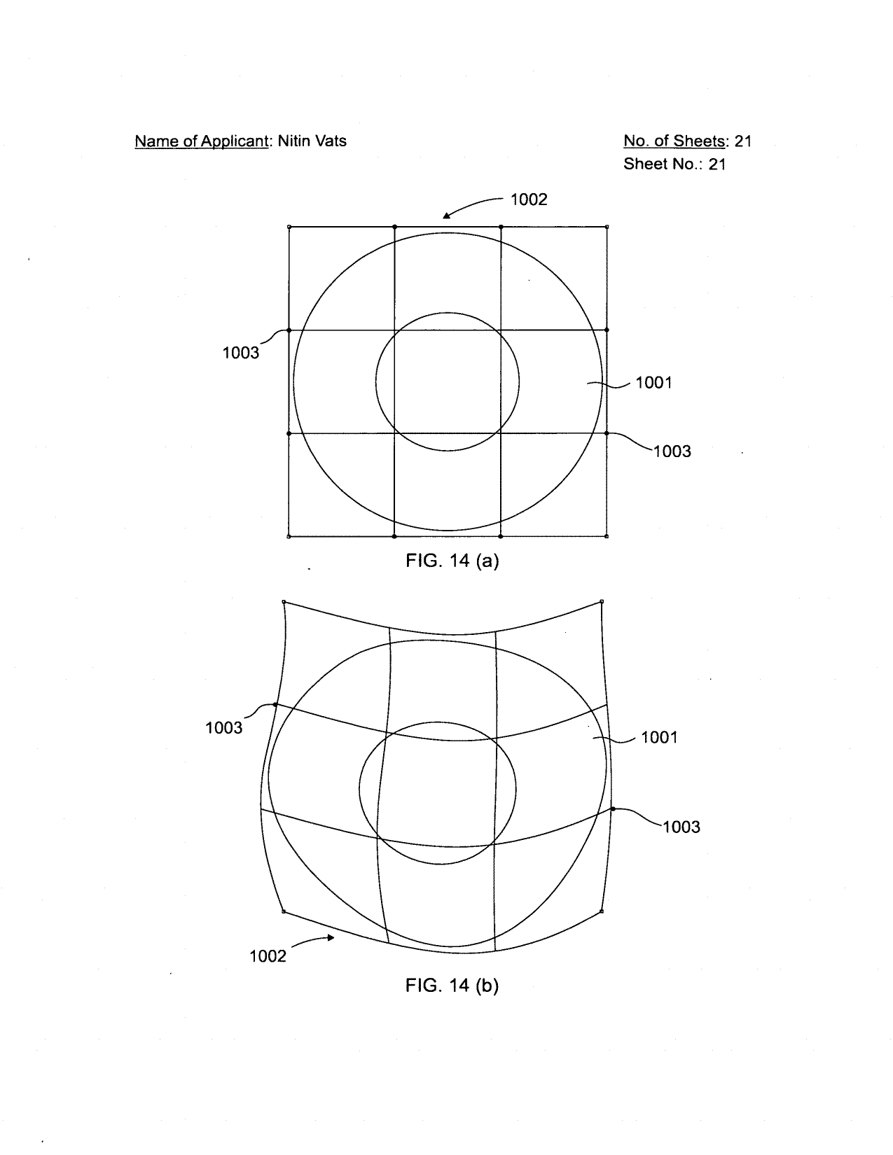

FIG. 14(a) shows an image 1002 having a ring shape 1001. Various nodes 1003 are shown on the image 1002 which after connecting draw an imaginary net on the ring 1001 to show the complete ring in different pieces just to understanding of the concept. FIG. 14(b) shows the warping of ring 1001 whereas warping means that points are mapped to points. This can be based mathematically on any function from (part of) the plane to the plane. If the function is injective the original can be reconstructed. If the function is a bijection, any image can be inversely transformed. Now 1001 is new shape of ring. 1003 shows the new position of the net points and lines between points 1003 has taken other shape so the image have been significantly changed to a new shape.

1. A method for generating a video using user image/video comprising:
providing an user image/video based on user input to a processor, the user image/video comprises a face;
receiving a scene video which comprises a body model of a person whereas body model of a person represent an image of a human with specified face region
extracting the face image/s from user image/video;
receiving a face position information in different frames of scene video;
processing the extracted face image/s and the frames of the scene video using the face position information;
generating processed video, the processed video comprises the face and the body model aligned together to represent a single person,
Whereas face region is the space for face with/without neck portion and/or hair in scene video frame,
Wherein the face position information comprises at least one of tilt of face, orientation of face, geometrical location of face region, boundary of face region and zoom of the face region, and
Whereas extracted face image is defined by the face or the face with/without neck portion and/or hair and/or nearby portion in user image.

2. The method according to the claim 1, wherein scene video is pre-processed to provide the scene video where body model of person is with removed face region.

3. The method according to claim 1, wherein extracting the face image comprises extracting the face cropped with neck from user image/video.

4. The method according to claim 1, wherein extracting the face image comprises extracting the face cropped with hair from user image/video.

5. The method according of to claim 1, wherein extracting the face image comprises extracting the region from user image, which includes face.

6. The method according to claim 1, wherein extracting the face image based on a extraction input, wherein the extraction input comprises selection of at least one of face, hair, neck, region around face.

7. The method according to claim 1, wherein the scene video is provided as per the body shape and/or size information provided by the user.

8. The method according to claim 1, wherein the person's body in scene video is reshaped to be in different shape and size.

9. The method according to claim 1, wherein the scene video comprises a background, and processing the scene video to remove the background.

10. The method according to claim 1, wherein the video with user image/sis processed with background image/video to generate processed video

11. The method according to claim 1, wherein the input scene video is provided with removed face with face position information of each frame:

12. The method according to claim 1, wherein at least a set of user images are provided which show same face in two slightly different perspective and are processed with a set of video which shows same scene in slightly different perspective to generate a set of video which show user image with body of person in scene video in slightly different perspective.

13. The method according to claim 1, comprising:
receiving a face area Information comprising information of at least an area showing hair, head and/or neck wearable, face wearable and an object covering face of body model, in different frames of scene video;
processing the extracted face image and the frames of the scene video using the information of face position information and the face area information.

14. The method according to claim 1, wherein the scene video frames comprises at least a vehicle, a background, a helmet, hair.

15. The method according to claim 1, wherein providing a group photo or a single person video or group video based on user input, and selecting a face based on selection user input, processing the group photo or the single person video or the group video based on the selection user input to generate the user image/video with face.

16. The method according to claim 1, wherein the scene video comprises more than one body model of persons, the method comprising:
providing one or more user image/video having one or more faces and selecting faces for body models based on user selection input.

17. The method according to claim 1, comprising:
processing the scene video to elect the face region of body model of the person in scene video by the processor from the scene video frames; and
generate face position information.

18. The method according to claim 1 comprising:
receiving skin tone input related to skin tone or detecting skin tone information from the face of the user image/video;
providing the video frames of the body model in matching skin tone either from a database based on the skin tone input/skin tone information or by processing the body model skin colour based on the skin tone input/skin tone information in scene video frames.

19. The method according to claim 1 comprises:
merging of extracted face image/s with the body model of person at neck in the scene video frame/s.

20. The method according to claim 1 comprising:
processing the extracted face in different frame/s of scene video with at least one of environment lighting, shading, overlay glass effect on/around the face.

21.-39. (canceled)
